(19) United States
(12) Patent Application Publication
(10) Pub. No.: US 2006/0222180 A1
(43) Pub. Date: Oct. 5, 2006

(54) Chip-scale transmitter for quantum cryptography

(76) Inventor: Brig Barnum Elliott, Arlington, MA (US)

Correspondence Address: HARRITY SNYDER, L.L.P., Suite 600, 11350 Random Hills Road, Fairfax, VA, 22030, US

(21) Appl. No.: 11/318,636

(22) Filed: Dec. 28, 2005

Related U.S. Application Data
(63) Continuation-in-part of application No. 10/271,103, filed on Oct. 15, 2002.
(63) Continuation-in-part of application No. 10/985,631, filed on Nov. 10, 2004.

(51) Int. Cl. H04L 9/00

(52) U.S. Cl. 380/263; 380/278; 380/279

(57) ABSTRACT

A quantum cryptographic key distribution (QKD) transmitter includes an integrated photonic circuit configured to distribute encryption key material using quantum cryptographic mechanisms. The integrated photonic circuit further includes a first photon source, an interferometer coupled to the first photon source and a phase modulator coupled to the interferometer and configured to modulate a phase of photons emitted by the first photon source.

### CROSS REFERENCE TO RELATED APPLICATIONS

The present application is a continuation-in-part of U.S. application Ser. No. 10/271,103 (Attorney Docket No. 02-4011), entitled “Systems and Methods for Framing Quantum Cryptographic Links” and filed Oct. 15, 2002; and U.S. application Ser. No. 10/985,631 (Attorney Docket No. 03-4061), entitled “Systems and Methods for Framing Quantum Cryptographic Links” and filed Nov. 10, 2004, the disclosures of which are incorporated by reference herein in their entirety.

### GOVERNMENT CONTRACT

The U.S. Government has a paid-up license in this invention and the right in limited circumstances to require the patent owner to license others on reasonable terms as provided for by the terms of Contract No. F30602-01-C-0170, awarded by the Defense Advanced Research Project Agency (DARPA).

### FIELD OF THE INVENTION

The present invention relates generally to cryptographic systems and, more particularly, to quantum cryptographic systems.

### BACKGROUND OF THE INVENTION

Within the field of cryptography, it is well recognized that the strength of any cryptographic system depends on, among other things, the key distribution technique employed. For conventional encryption to be effective, such as a symmetric key system, two communicating parties must share the same key and that key must be protected from access by others. The key must, therefore, be distributed to each of the parties. FIG. 1 shows one form of a conventional key distribution process. As shown in FIG. 1, for a party, Bob, to decrypt ciphertext encrypted by a party, Alice, Alice or a third party must share a copy of the key with Bob. This distribution process can be implemented in a number of conventional ways including the following: 1) Alice can select a key and physically deliver the key to Bob; 2) a third party can select a key and physically deliver the key to Bob; 3) if Alice and Bob both have an encrypted connection to a third party, the third party can deliver a key on the encrypted links to Alice and Bob; 4) if Alice and Bob have previously used an old key, Alice can transmit a new key to Bob by encrypting the new key with the old; and 5) Alice and Bob may agree on a shared key via a one-way mathematical algorithm, such as Diffie-Helman key agreement. All of these distribution methods are vulnerable to interception of the distributed key by an eavesdropper Eve, or by Eve “cracking” the supposedly one-way algorithm. Eve can eavesdrop and intercept or copy a distributed key and then subsequently decrypt any intercepted ciphertext that is sent between Bob and Alice. In conventional cryptographic systems, this eavesdropping may go undetected, with the result being that any ciphertext sent between Bob and Alice is compromised.

To combat these inherent deficiencies in the key distribution process, researchers have developed a key distribution technique called quantum cryptography. Quantum cryptography employs quantum systems and applicable fundamental principles of physics to ensure the security of distributed keys. Heisenberg's uncertainty principle mandates that any attempt to observe the state of a quantum system will necessarily induce a change in the state of the quantum system. Thus, when very low levels of matter or energy, such as individual photons, are used to distribute keys, the techniques of quantum cryptography permit the key distributor and receiver to determine whether any eavesdropping has occurred during the key distribution. Quantum cryptography, therefore, prevents an eavesdropper, like Eve, from copying or intercepting a key that has been distributed from Alice to Bob without a significant probability of Bob's or Alice's discovery of the eavesdropping.

A well known quantum key distribution scheme involves a quantum channel, through which Alice and Bob send keys using polarized or phase encoded photons, and a public channel, through which Alice and Bob send ordinary messages. Since these polarized or phase encoded photons are employed for QKD, they are often termed QKD photons. The quantum channel is a transmission medium that isolates the QKD photons from interaction with the environment. The public channel may include a channel on any type of communication network such as a Public Switched Telephone network, the Internet, or a wireless network. An eavesdropper, Eve, may attempt to measure the photons on the quantum channel. Such eavesdropping, however, will induce a measurable disturbance in the photons in accordance with the Heisenberg uncertainty principle. Alice and Bob use the public channel to discuss and compare the photons sent through the quantum channel. If, through their discussion and comparison, they determine that there is no evidence of eavesdropping, then the key material distributed via the quantum channel can be considered completely secret.

FIG. 2 illustrates a well-known scheme 200 for quantum key distribution in which the polarization of each photon is used for encoding cryptographic values. To begin the quantum key distribution process, Alice generates random bit values and bases 205 and then encodes the bits as polarization states (e.g., 0°, 45°, 90°, 135°) in sequences of photons sent via the quantum channel 210 (see row 1 of FIG. 3). Alice does not tell anyone the polarization of the photons she has transmitted. Bob receives the photons and measures their polarization along either a rectilinear or diagonal basis with randomly selected and substantially equal probability. Bob records his chosen basis (see row 2 of FIG. 3) and his measurement results (see row 3 of FIG. 3). Bob and Alice discuss 215, via the public channel 220, which basis he has chosen to measure each photon. Bob, however, does not inform Alice of the result of his measurements. Alice tells Bob, via the public channel, whether he has made the measurement along the correct basis (see row 4 of FIG. 3). In a process called “sifting” 225, both Alice and Bob then discard all cases in which Bob has made the measurement along the wrong basis and keep only the ones in which Bob has made the measurement along the correct basis (see row 5 of FIG. 3).

Alice and Bob then estimate 230 whether Eve has eavesdropped upon the key distribution. To do this, Alice and Bob must agree upon a maximum tolerable error rate. Errors can occur due to the intrinsic noise of the quantum channel and eavesdropping attack by a third party. Alice and Bob choose randomly a subset of photons m from the sequence of photons that have been transmitted and measured on the same basis. For each of the m photons, Bob announces publicly his measurement result. Alice informs Bob whether his result is the same as what she had originally sent. They both then compute the error rate of the m photons and, since the measurement results of the m photons have been discussed publicly, the polarization data of the m photons are discarded. If the computed error rate is higher than the agreed upon tolerable error rate (typically no more than about 15%), Alice and Bob infer that substantial eavesdropping has occurred. They then discard the current polarization data and start over with a new sequence of photons. If the error rate is acceptably small, Alice and Bob adopt the remaining polarizations, or some algebraic combination of their values, as secret bits of a shared secret key 235, interpreting horizontal or 45 degree polarized photons as binary 0's and vertical or 135 degree photons as binary 1's (see row 6 of FIG. 3). Conventional error detection and correction processes, such as parity checking or convolutional encoding, may further be performed on the secret bits to correct any bit errors due to the intrinsic noise of the quantum channel.

Alice and Bob may also implement an additional privacy amplification process 240 that reduces the key to a small set of derived bits to reduce Eve's knowledge of the key. If, subsequent to discussion 215 and sifting 225, Alice and Bob adopt n bits as secret bits, the n bits can be compressed using, for example, a hash function. Alice and Bob agree upon a publicly chosen hash function ƒ and take K=ƒ(n bits) as the shared r-bit length key K. The hash function randomly redistributes the n bits such that a small change in bits produces a large change in the hash value. Thus, even if Eve determines a number of bits of the transmitted key through eavesdropping, and also knows the hash function ƒ, she still will be left with very little knowledge regarding the content of the hashed r-bit key K. Alice and Bob may further authenticate the public channel transmissions to prevent a “man-in-the-middle” attack in which Eve masquerades as either Bob or Alice.

### SUMMARY OF THE INVENTION

In accordance with the purpose of the invention as embodied and broadly described herein, a quantum cryptographic key distribution (QKD) transmitter may include an integrated photonic circuit configured to distribute encryption key material using quantum cryptographic mechanisms.

In another implementation, a system may include an interferometer formed in an integrated circuit and a first laser formed in the integrated circuit and coupled to a first side of the interferometer. The integrated circuit may further include an attenuator formed in the integrated circuit and coupled to a second side of the interferometer and a phase modulator formed in the integrated circuit and coupled to the interferometer.

In a further implementation, a QKD transmitter may include an integrated photonic circuit configured to distribute encryption key material using quantum cryptographic mechanisms via multiple channels.

In an additional implementation, a QKD transmitter may include an integrated photonic circuit configured to distribute encryption key material using at least one of dim light pulses or single photon light pulses and synchronization light pulses.

### BRIEF DESCRIPTION OF THE DRAWINGS

The accompanying drawings, which are incorporated in and constitute a part of this specification, illustrate one or more exemplary embodiments of the invention and, together with the description, explain the invention. In the drawings,

FIG. 1 illustrates conventional cryptographic key distribution and ciphertext communication;

FIG. 2 illustrates a conventional quantum cryptographic key distribution (QKD) process;

FIG. 3 illustrates conventional quantum cryptographic sifting and error correction;

FIG. 4 illustrates an exemplary network in which systems and methods, consistent with the present invention, may be implemented;

FIG. 5 illustrates an exemplary configuration of a QKD endpoint of FIG. 4 consistent with the present invention;

FIG. 6 illustrates exemplary components of the quantum cryptographic transceiver of FIG. 5 consistent with principles of the invention;

FIG. 7 illustrates a high-level diagram of exemplary electronics and integrated photonics of the QKD transmitter of FIG. 6 consistent with principles of the invention;

FIG. 8 illustrates an exemplary implementation of the integrated photonics of FIG. 7 consistent with principles of the invention;

FIG. 9 illustrates an exemplary implementation in which a delay line is added to one arm of the interferometer of FIG. 8 consistent with principles of the invention;

FIG. 10 illustrates an exemplary implementation in which a continuous wave laser and optical amplifier is used in the integrated photonics of FIG. 8 consistent with principles of the invention;

FIG. 11 illustrates an exemplary implementation in which integrated photonics of the QKD transmitter distribute encryption key material via multiple channels consistent with principles of the invention;

FIG. 12 illustrates exemplary components of the QKD transmitter of FIG. 6 consistent with one implementation of the invention;

FIG. 13 illustrates exemplary components of the QKD receiver of FIG. 6 consistent with principles of the invention;

FIG. 14 is a diagram illustrating exemplary relationships between bright and dim pulses and framing at the QKD transmitter and receiver;

FIGS. 15A-15C are diagrams that illustrate exemplary symbols used to encode QKD framing information consistent with principles of the invention;

FIG. 16 is a diagram illustrating an exemplary frame structure consistent with principles of the invention;

FIGS. 17 and 18 are flow charts that illustrate an exemplary QKD frame transmission process consistent with principles of the invention; and

FIGS. 19 and 20 are flow charts that illustrate an exemplary QKD frame reception process consistent with principles of the invention.

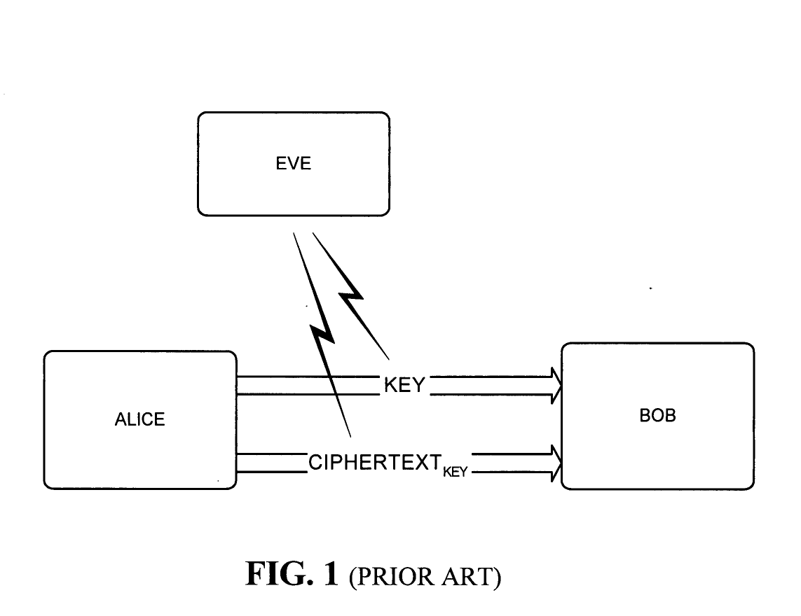

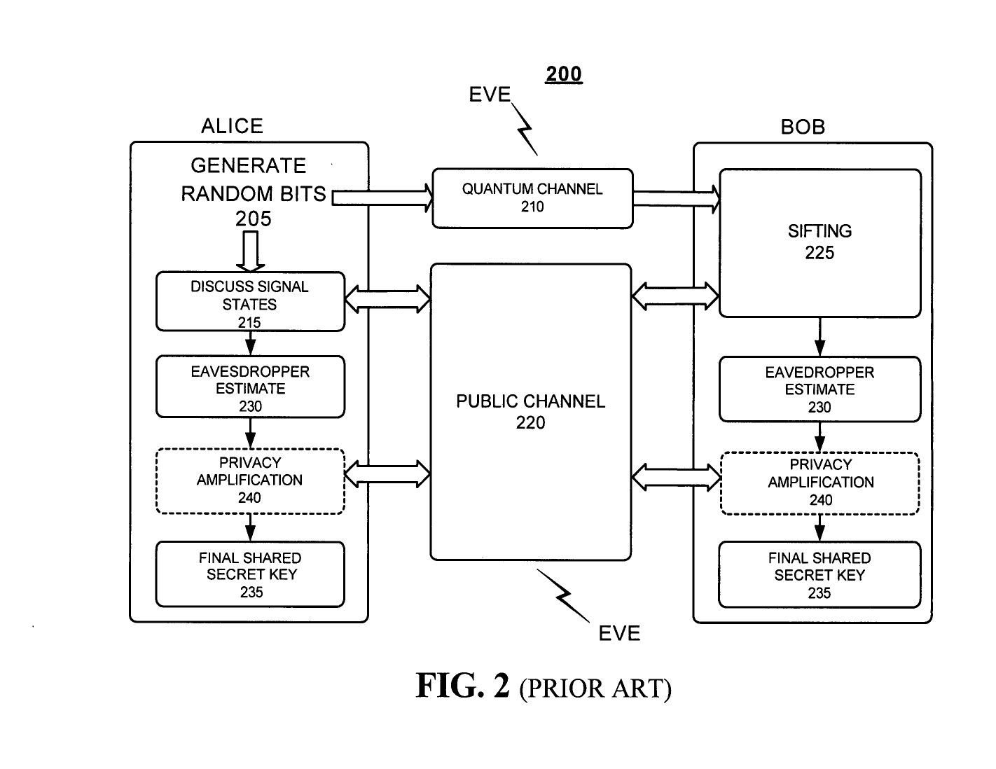

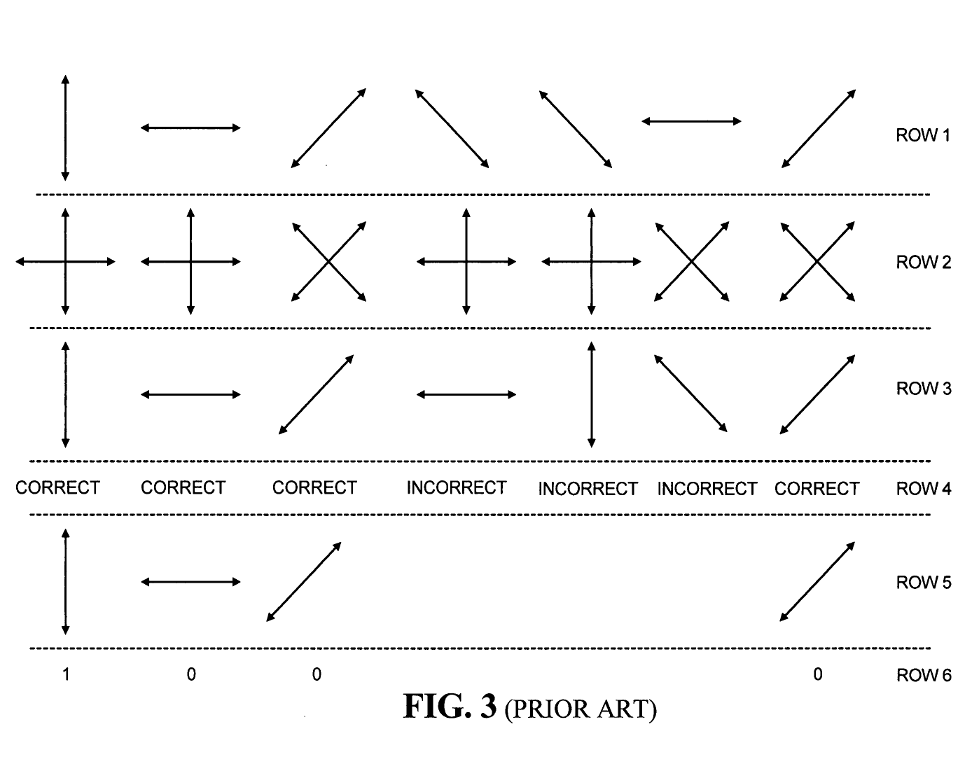

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Existing QKD transmitters consist of a number of discrete optical components such as a laser source, fiber optic strands that form an interferometer, lithium-niobate phase modulator, attenuator, etc. The smallest package of existing QKD transmitters is, thus, the size of a suitcase and costs perhaps $10,000 to $30,000 to manufacture. Consistent with aspects of the invention, this relatively large existing QKD transmitter can be replaced with a single chip, or pair of chips, for a manufacturing cost that should be well under $1,000, and perhaps under $100. The photonics for the QKD transmitter, consistent with aspects of the invention, may be integrated on a single chip that may be fabricated from III-V semiconductor (e.g., InGa As) and/or silicon or silica. In some implementations, the electronics for the QKD transmitter may be integrated on the same chip as the photonics, thus, providing a complete QKD transmitter on a single chip. In other implementations, a separate chip for the electronics may be supplied to provide a two-chip QKD transmitter (e.g., one chip contains the electronics in CMOS, and the other chip contains the photonics on III-V semiconducting material). The resulting chip-scale QKD transmitter additionally may be sealed within a tamper-evident case to increase the overall security of the QKD system (e.g., by ceasing operation immediately if an interloper (Eve) attempts to inspect or modify the QKD transmitter).

Aspects of the invention may be particularly useful in asymmetric networks with multiple transmitters and a single (more expensive receiver), such as emerging fiber-based cable systems and next-generation fiber systems for local telephony. Aspects of the invention may be implemented in Passive Optical Networks (PONs), such as in the system described in co-pending U.S. application Ser. No. ______ (Attorney Docket No. 04-5009) and entitled “Quantum Cryptography on a Multi-Drop Optical Network,” the disclosure of which is incorporated by reference herein in its entirety.

### Exemplary Network

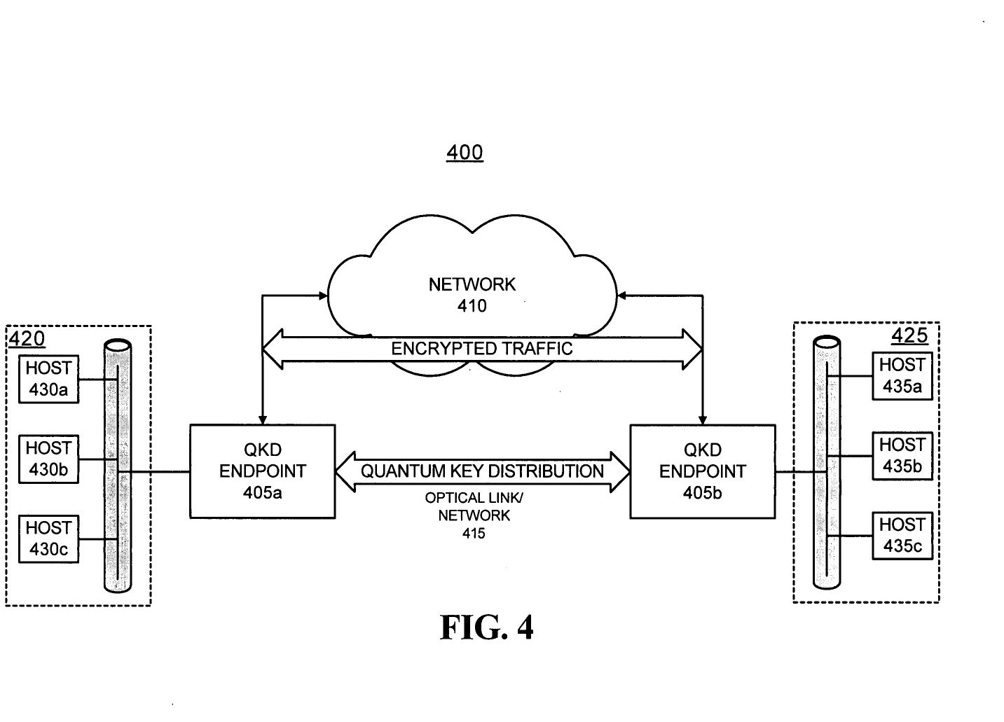

FIG. 4 illustrates an exemplary network 400 in which systems and methods, consistent with principles of the invention, can be implemented to distribute encryption keys via quantum cryptographic mechanisms. Network 400 may include QKD endpoints 405a and 405b connected via a network 410 and an optical link/network 415. QKD endpoints 405a and 405b may each include a host or a server. QKD endpoints 405a and 405b may further connect to local area networks (LANs) 420 or 425. LANs 420 and 425 may further connect with hosts 430a-430c and 435a-435c, respectively. Network 410 can include one or more networks of any type, including a Public Land Mobile Network (PLMN), Public Switched Telephone Network (PSTN), LAN, metropolitan area network (MAN), wide area network (WAN), Internet, or Intranet. Network 410 may also include a dedicated fiber link or a dedicated freespace optical or radio link. The one or more PLMNs may further include packet-switched sub-networks, such as, for example, General Packet Radio Service (GPRS), Cellular Digital Packet Data (CDPD), and Mobile IP sub-networks.

Optical link/network 415 may include a link that may carry light throughout the electromagnetic spectrum, including light in the human visible spectrum and light beyond the human-visible spectrum, such as, for example, infrared or ultraviolet light. The link may include, for example, a conventional optical fiber. Alternatively, the link may include a free-space optical path, such as, for example, a path through the atmosphere or outer space, or even through water or other transparent media. As another alternative, the link may include a hollow optical fiber that may be lined with photonic band-gap material.

Furthermore, optical link/network 415 may include a QKD network that includes one or more QKD switches (not shown) for distributing encryption keys between a source QKD endpoint (e.g., QKD endpoint 405a) and a destination QKD endpoint (e.g., QKD endpoint 405b). Such a QKD network may include the QKD network described in U.S. patent application Ser. No. 09/943,709 (Attorney Docket No. 01-4015), entitled “Systems and Methods for Path Set-up in a Quantum Key Distribution Network,” and U.S. patent application Ser. No. 09/944,328 (Attorney Docket No. 00-4069), entitled “Quantum Cryptographic Key Distribution Networks with Untrusted Switches,” the entire disclosures of which are incorporated by reference herein.

QKD endpoints 405 may distribute Quantum Cryptographic keys via optical link/network 415. Subsequent to quantum key distribution via optical link/network 415, QKD endpoint 405a and QKD endpoint 405b may encrypt traffic using the distributed key(s) and transmit the traffic via network 410.

It will be appreciated that the number of components illustrated in FIG. 4 is provided for explanatory purposes only. A typical network may include more or fewer components that are illustrated in FIG. 4.

### Exemplary QKD Endpoint

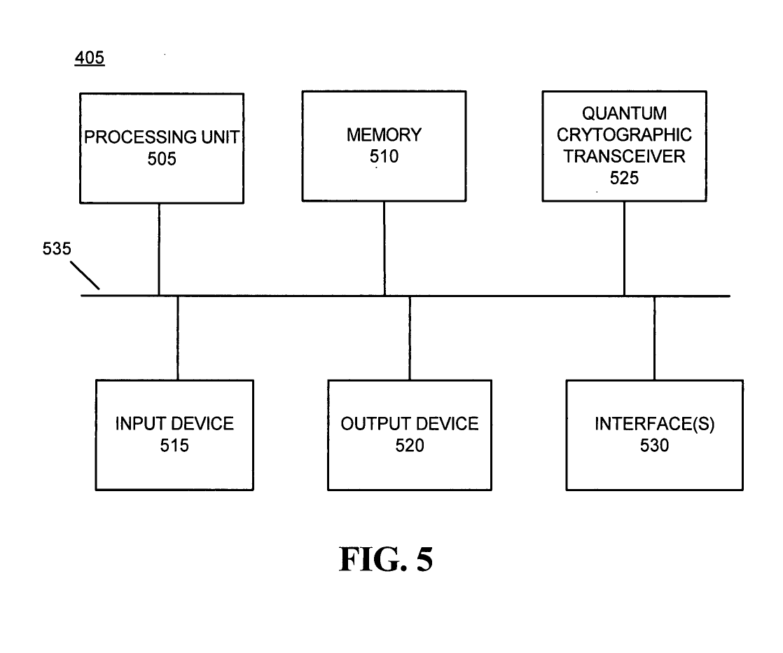

FIG. 5 illustrates exemplary components of a QKD endpoint 405 consistent with the present invention. QKD endpoint 405 may include a processing unit 505, a memory 510, an input device 515, an output device 520, a quantum cryptographic transceiver 525, an interface(s) 530 and a bus 535. Processing unit 505 may perform all data processing functions for inputting, outputting, and processing of QKD endpoint data. Memory 510 may include Random Access Memory (RAM) that provides temporary working storage of data and instructions for use by processing unit 505 in performing processing functions. Memory 510 may additionally include Read Only Memory (ROM) that provides permanent or semi-permanent storage of data and instructions for use by processing unit 505. Memory 510 can also include large-capacity storage devices, such as a magnetic and/or optical recording medium and its corresponding drive.

Input device 515 permits entry of data into QKD endpoint 405 and may include a user interface (not shown). Output device 520 permits the output of data in video, audio, and/or hard copy format. Quantum cryptographic transceiver 525 may include mechanisms for transmitting and receiving encryption keys using quantum cryptographic techniques via link/network 415. Interface(s) 530 may interconnect QKD endpoint 405 with network 410. Bus 535 interconnects the various components of QKD endpoint 405 to permit the components to communicate with one another.

### Exemplary Quantum Cryptographic Transceiver

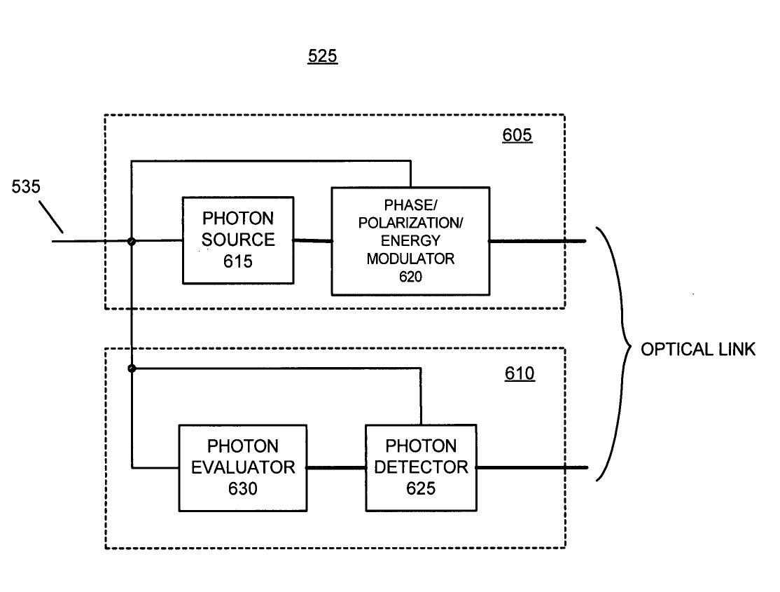

FIG. 6 illustrates exemplary components of quantum cryptographic transceiver 525 of QKD endpoint 405 consistent with the present invention. Quantum cryptographic transceiver 525 may include a QKD transmitter 605 and a QKD receiver 610. QKD transmitter 605 may include a photon source 615 and a phase/polarization/energy modulator 620. Photon source 615 can include, for example, a conventional laser. Photon source 615 may produce photons according to instructions provided by processing unit 505. Photon source 615 may produce photons of light with wavelengths throughout the electromagnetic spectrum, including light in the human visible spectrum and light beyond the human-visible spectrum, such as, for example, infrared or ultraviolet light. Phase/polarization/energy modulator 620 can include, for example, Mach-Zehnder interferometers. Phase/polarization/energy modulator 620 may encode outgoing photons from the photon source according to commands received from processing unit 505 for transmission across an optical link, such as link 415.

QKD receiver 610 may include a photon detector 625 and a photon evaluator 630. Photon detector 625 can include, for example, conventional avalanche photo detectors (APDs) or conventional photo-multiplier tubes (PMTs). Photon detector 625 can also include cryogenically cooled detectors that sense energy via changes in detector temperature or electrical resistivity as photons strike the detector apparatus. Photon detector 625 can detect photons received across the optical link. Photon evaluator 630 can include conventional circuitry for processing and evaluating output signals from photon detector 625 in accordance with quantum cryptographic techniques.

### Exemplary Chip-Scale QKD Transmitter

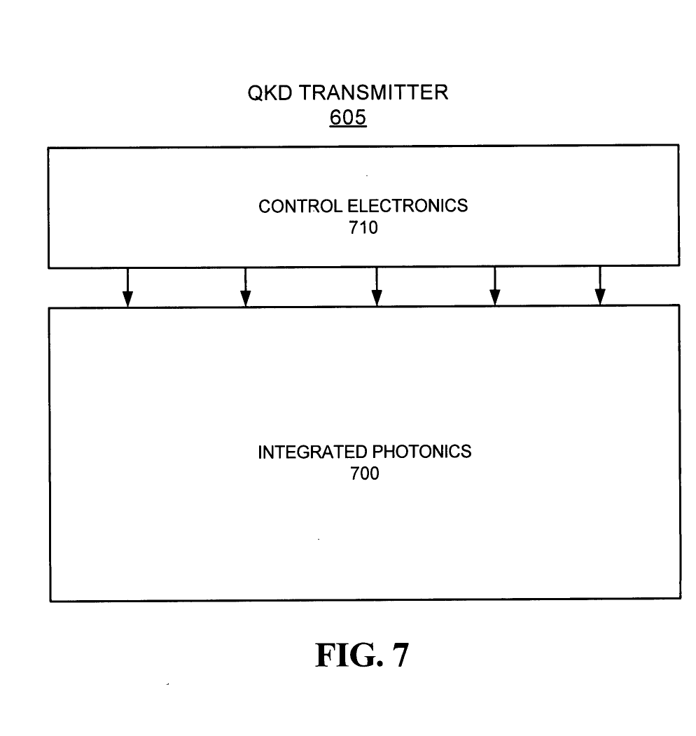

FIG. 7 is a diagram that depicts an aspect of the invention in which QKD transmitter 605 of FIG. 6 is implemented as an integrated circuit. In this implementation, QKD transmitter 605 may include integrated photonics 700 and control electronics 710. Integrated photonics 700 may include the photonic components of QKD transmitter 605 implemented as integrated circuitry on one or more semiconductor chips. The integrated circuitry may include, for example, components implemented in III-V semiconductors, silica, or silicon. Control electronics 710 may, in one implementation, include integrated electronics for controlling the operation of QKD transmitter 605. In other implementations, control electronics 710 may include discrete electronic components. Control electronics 710 may be implemented on the same semiconductor chip(s) as integrated photonics 700, or control electronics 710 may be implemented on a different semiconductor chip(s) than integrated photonics 700.

### Exemplary Chip-Scale QKD Transmitter Components

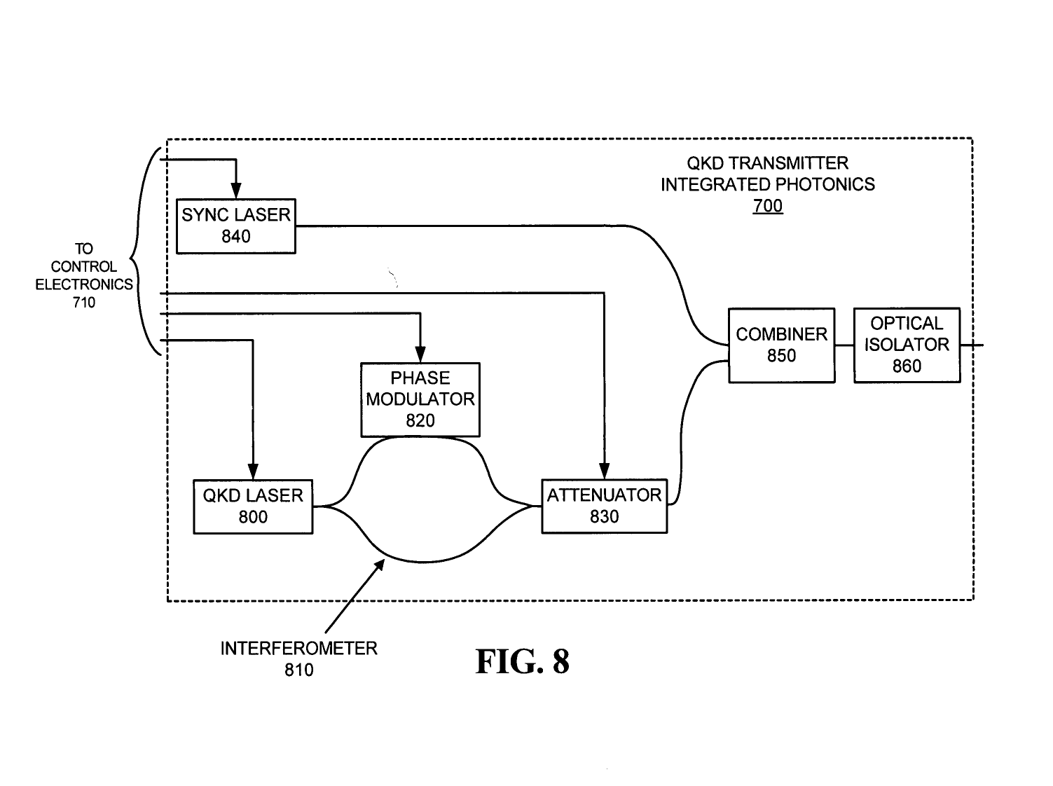

FIG. 8 illustrates exemplary components of integrated photonics 700 of QKD transmitter 605. Integrated photonics 700 may include a QKD laser 800, an interferometer 810, a phase modulator 820, an attenuator 830, a synchronization (SYNC) laser 840, a combiner 850 and an optical isolator 860. QKD laser 800 may include an integrated laser that emits pulses of light at a known frequency. For example, in one implementation, laser 800 may emit light at a wavelength of 1550.12 nm. QKD laser 800 may be driven by electrical signals from control electronics 710. Interferometer 810 may include an integrated waveguide that provides two paths for light waves emitted from QKD laser 800 towards the output of QKD transmitter 605. Interferometer 810 may include an unbalanced Mach-Zehnder (MZ) interferometer in which each pulse of light that passes through the interferometer emerges as two distinct probability density functions separated by time, where the time is related to the difference in length between the two interferometer arms.

Phase modulator 820 may include any type of existing integrated optical phase modulator, such as, for example, a lithium niobate phase modulator. Phase modulator 820 may randomly apply one of four known phase modulations to the light pulse from QKD laser 800 that passes through modulator 820 in order to encode the basis and value pair used in the quantum cryptographic protocol (discussed in more detail below). Phase modulator 820 may be driven by electrical signals from control electronics 710. In one implementation, QKD laser 800, interferometer 810 and phase modulator 820 may be integrated on a single chip as described in “Design and Performance of a Monolithically Integrated Widely Tunable All-Optical Wavelength Converter With Independent Phase Control,” IEEE Photonics Technology Letters, Vol. 16, No. 10, October 2004, pgs. 2299-2301.

Attenuator 830 may reduce the light power emitted from QKD laser 800 such that a very small number of photons (e.g., a single photon) is emitted at the output of attenuator 830 for each light pulse emitted by QKD laser 800. Attenuator 830 may be driven by electrical signals from control electronics 710 to provide variable attenuation (e.g., for implementing “decoy state” techniques for QKD). In some implementations, however, attenuator 830 may provide a fixed attenuation to light pulses from QKD laser 800.

SYNC laser 840 may emit pulses of light at a known frequency (e.g., 1550.92 nm) that may be different than the frequency of QKD laser 800. SYNC laser 840 may be driven by electrical signals from control electronics 710. SYNC laser 840 may provide synchronization pulses for “framing” the light pulses emitted by QKD laser 800 (as described in more detail below). Combiner 850 may merge multiple incoming light waveguides into a single outgoing light waveguide (e.g., merge light from SYNC laser 840 with the light from QKD laser 800). In one implementation, combiner 850 may include a Dense Wavelength Division Multiplexing (DWDM) device. Optical isolator 860 may allow light to pass in one direction (e.g., outwards from the transmitter) but stops light from passing in the other direction (e.g., inwards into the transmitter). Optical isolator 860 may prevent “probing” attacks in which Eve attempts to view the internal settings of the transmitter by sending short pulses of light into the transmitter and observing the reflections. Attenuator 830, SYNC laser 840, combiner 850 and optical isolator 860 may be integrated on a chip using existing techniques.

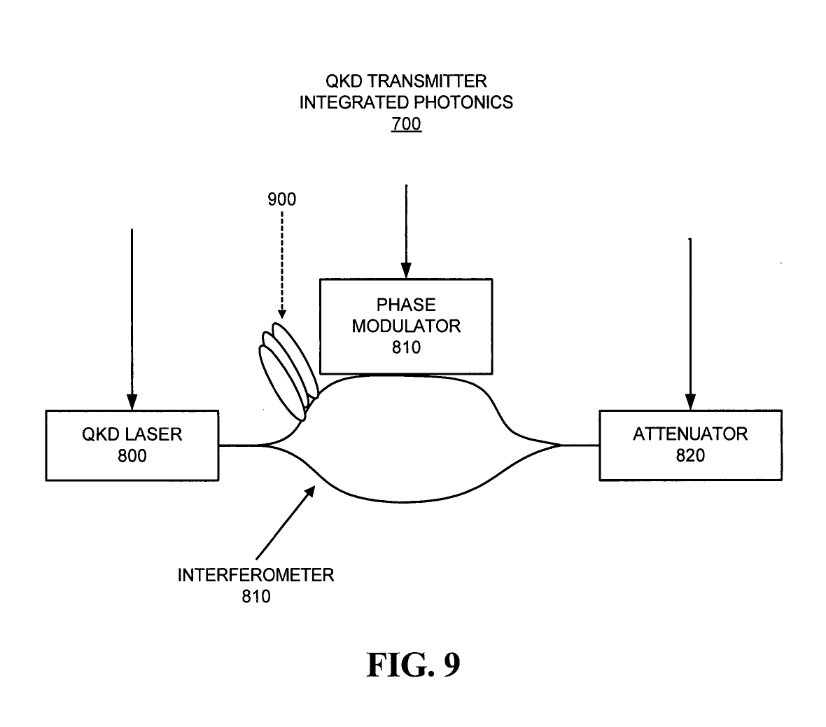

FIG. 9 illustrates one exemplary implementation in which a delay line 900 has been added to an arm of interferometer 810. It may be the case that the arm-length difference in interferometer 810 must be relatively long compared to the overall chip-size. Therefore, a special mechanism for artificially adding a delay to one arm of interferometer 810 may be needed in order to obtain the desired time difference between the two probability density functions for light pulses emerging from interferometer 810. In such a case, delay line 900 may be added in one arm of interferometer 810. Delay line 900 may be implemented using a “racetrack” approach that employs arrayed, on-chip waveguide buffers (not shown) as memory components. Input symbols may be stored for integer multiples of the delay of one arm of interferometer 810. The symbols may be switched in and out of the buffers with, for example, a two-by-two switch. Delay line 900 may be implemented, for example, in a hybrid of silica and a III-V semiconductor (e.g., InGaAsP).

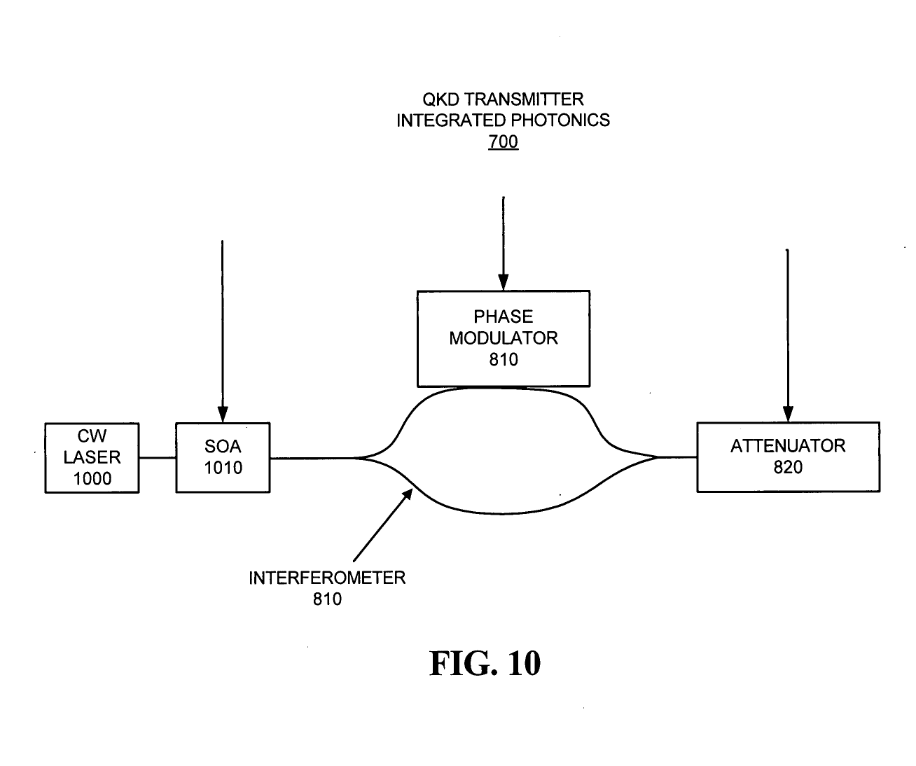

FIG. 10 illustrates another exemplary implementation in which QKD laser 800 of FIG. 8 is run in a continuous-wave (CW) mode (i.e., always emitting light). In the CW implementation of FIG. 10, the light from CW laser 1000 may be modulated brighter or dimmer by semiconductor optical amplifier (SOA) 1010. SOA 1010 may be driven by electrical signals from control electronics 710 (not shown). Dim light exiting from SOA 1010 may also be subsequently attenuated by attenuator 820 such that essentially no light is emitted during “dim” periods, while during “bright” periods the emitted light may be attenuated down to a very small number of photons (e.g., a single photon). In some implementations, several different “bright” levels may be used, where attenuator 820 attenuates “bright” light from CW laser 1000 down to single-photon, two-photon, three-photon, etc. levels. The exemplary implementation of FIG. 10 may run faster, and produce less “chirping” in the emitted light, as compared to the “pulsed” laser implementation of FIG. 8.

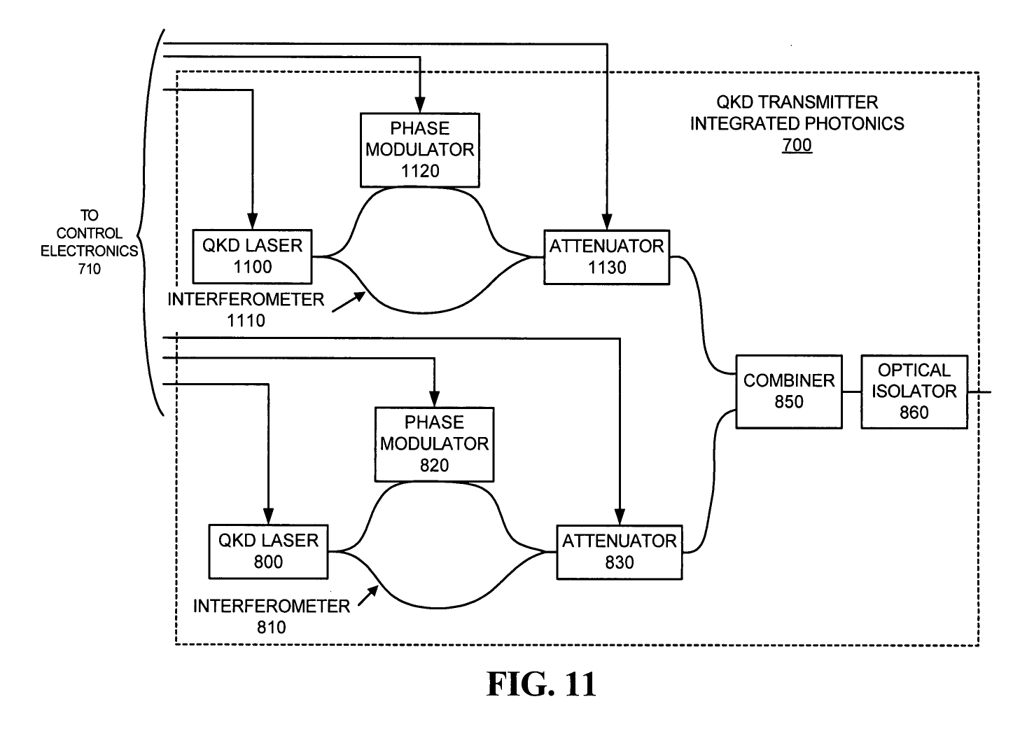

FIG. 11 illustrates components of an exemplary implementation in which integrated photonics 700 of QKD transmitter 605 distribute encryption key material via multiple channels. In the exemplary implementation of FIG. 11, integrated photonics 700 generates light pulses using multiple different wavelengths and modulates the different wavelength light pulses in parallel using separate interferometers and phase modulators. As shown in FIG. 11, integrated photonics 700 may include QKD laser 800, interferometer 810, phase modulator 820 and attenuator 830 for generating light pulses of a first wavelength, modulating the phase of the generated light pulses and attenuating the light pulses to a desired number of photons per light pulse (e.g., one photon per light pulse).

Integrated photonics 700 may further include QKD laser 1100, interferometer 1110, phase modulator 1120 and attenuator 1130 for generating light pulses of a second wavelength, modulating the phase of the generated light pulses and attenuating the light pulses to a desired number of photons per pulse (e.g., one photon per light pulse).

Combiner 850 may merge multiple incoming light waveguides into a single outgoing light waveguide (e.g., merge light from QKD lasers 800 and 1100). In one implementation, combiner 850 may include a Dense Wavelength Division Multiplexing (DWDM) device. Optical isolator 860 may allow light to pass in one direction (e.g., from combiner 850 outwards from the transmitter) but stops light from passing in the other direction (e.g., inwards into the transmitter). Light pulses from a single SYNC laser (not shown) may additionally be multiplexed with the light pulses from QKD lasers 800 and 100, by combiner 850, to provide timing and framing information for the receiving QKD endpoint.

FIG. 11 depicts two different channels for distributing encryption key material via quantum cryptography. However, multiple different channels (e.g., greater than two) may be implemented consistent with principles of the invention. Multiple different sets of QKD lasers, interferometers, phase modulators and attenuators may be placed in parallel and combined in combiner 850. The use of multiple different channels, thus, effectively enables multiple QKD transmitters to operate in parallel, thereby, permitting high throughput in a QKD system. The multiple different transmissions may be multiplexed by either wavelength or by time, or by a combination of these two techniques. For example, one implementation may run 40 different QKD transmitters on a single chip, giving each QKD laser its own transmission wavelength. In such an implementation, the combiner may then be a DWDM multiplexor that combines all of the distinct wavelengths on a single outbound fiber. Alternatively, the multiple QKD transmitters may be employed with staggered pulse timings so that the outgoing pulses can be time-multiplexed onto the same wavelength of a fiber.

### Exemplary QKD Transmitter

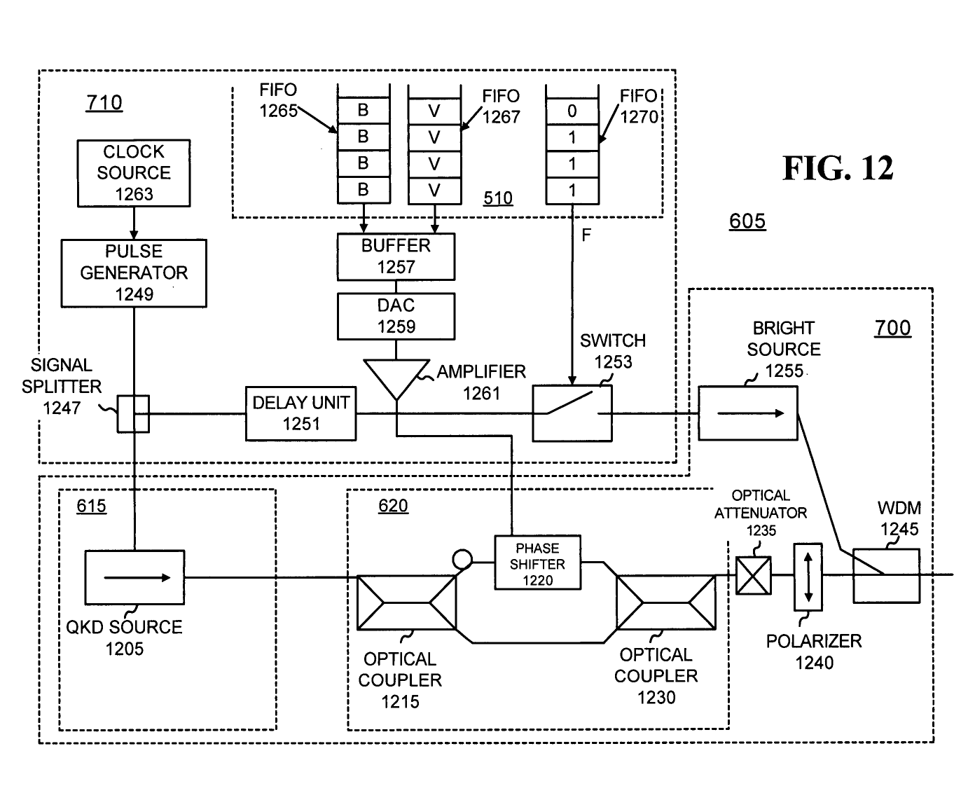

FIG. 12 illustrates exemplary components of integrated photonics 700 and control electronics 710 of QKD transmitter 605 consistent with one specific detailed implementation of the invention. Photon source 615 of integrated photonics 700 may include a QKD source 1205. Phase modulator 620 of integrated photonics 700 may include an optical coupler 1215, a phase shifter 1220 and an optical coupler 1230. Integrated photonics 700 may further include an optical attenuator 1235, a polarizer 1240, a wavelength division multiplexer (WDM) 1245 and a bright source 1255. Control electronics 710 may include a signal splitter 1247, a pulse generator 1249, a delay unit 1251, a switch 1253, a buffer 1257, a digital-to-analog converter (DAC) 1259, an amplifier 1261, a clock source 1263, and multiple First-in-First-Out (FIFO) queues 1265, 1267 and 1270 of memory 510.

Integrated photonics 700 may include a laser that produces QKD photon pulses (i.e., “dim” photon pulses) at, for example, a wavelength of 1550.12 nm. The number of photons contained in each photon pulse produced by QKD source 1205 may be statistically distributed according to, for example, a Poisson distribution. According to such a statistical distribution, a series of photon pulses emitted by QKD source 1205, when attenuated by optical attenuator 1235, may include less than, or equal to, a threshold level of photons per pulse on average (e.g., on average less than or equal to 1 photon/pulse). Optical coupler 1215 may include, for example, a 50/50 coupler, and may couple photon pulses from QKD source 1205 to phase shifter 1220. Phase shifter 1220 may include a Mach-Zehnder interferometer that is modulated to one of four phases to encode both a basis value and a cryptographic key symbol value in each photon's self interference. For example, a cryptographic key symbol of “0” or “1” may be encoded in either of two randomly selected non-orthogonal bases. In one implementation, the “0” key symbol can be encoded by either a phase shift of 0 (basis 0) or π/2 (basis 1) and the “1” key symbol can be encoded by either a π phase shift (basis 0) or a 3π/2 phase shift (basis 1). Four different basis and key symbol pairs (basis, symbol) may, thus, be encoded by four different phase shifts (0, π/2, π, or 3π/2). This may be achieved by applying four different voltages to phase shifter 1220. These voltages may be applied, for example, by buffer 1257, DAC 1259 and amplifier 1261, which may convert a basis value B received from FIFO 1265 and cryptographic key symbol values V received from FIFO 1267 to one of four different voltages for inducing a corresponding phase shift in phase shifter 1220. Phase shifter 1220 may produce phase shifts in photon pulses received from QKD source 1205 in accordance with analog voltages from amplifier 1261.

Optical coupler 1230 may include, for example, a 50/50 coupler, and may couple the signals from phase shifter 1220 and from the other arm of the interferometer to optical attenuator 1235. Polarizer 1240 may only pass light propagating along one axis of polarization maintaining optical fiber, thus, removing mis-timed replicas of the “dim” pulse from optical attenuator 1235 that may have been generated by misaligned polarization maintaining components in the interferometer. WDM 1245 may multiplex the “dim” photon pulses from QKD source 1205 and attenuator 1235 with “bright” photon pulses generated by bright source 1255. Bright source 1255 may include a laser that produces multi-photon pulses (e.g., “bright” pulses, with each pulse including numerous photons) at, for example, a wavelength of 1550.92 nm.

A series of trigger values may be received from clock source 1263 for triggering pulse generator 1249. When triggered, pulse generator 1249 may send an output electrical pulse that is split, via signal splitter 1247, into two identical pulses. One of the pulses from signal splitter 1247 may drive QKD source 1205, and another of the pulses from signal splitter 1247 may pass through delay unit 1251 and switch 1253 to drive bright source 1255. Framing information may be encoded on the clock pulse from clock source 1263 by using switch 1253 to produce a missing pulse in response to a ‘0’ value on the ‘F’ line from FIFO 1270. Delay unit 1251 may provide a stable time relationship between “dim” pulses emitted from QKD source 1205, via attenuator 1235, and “bright” pulses emitted from bright source 1255. In one exemplary implementation, the “dim” pulses from QKD source 1205 may be timed such that any two “dim” pulses are separated by approximately 17.8 ns, and each “bright” pulse from bright source 1255 lags a corresponding “dim” pulse from QKD source 1205 by approximately 20.5 ns.

### Exemplary QKD Receiver

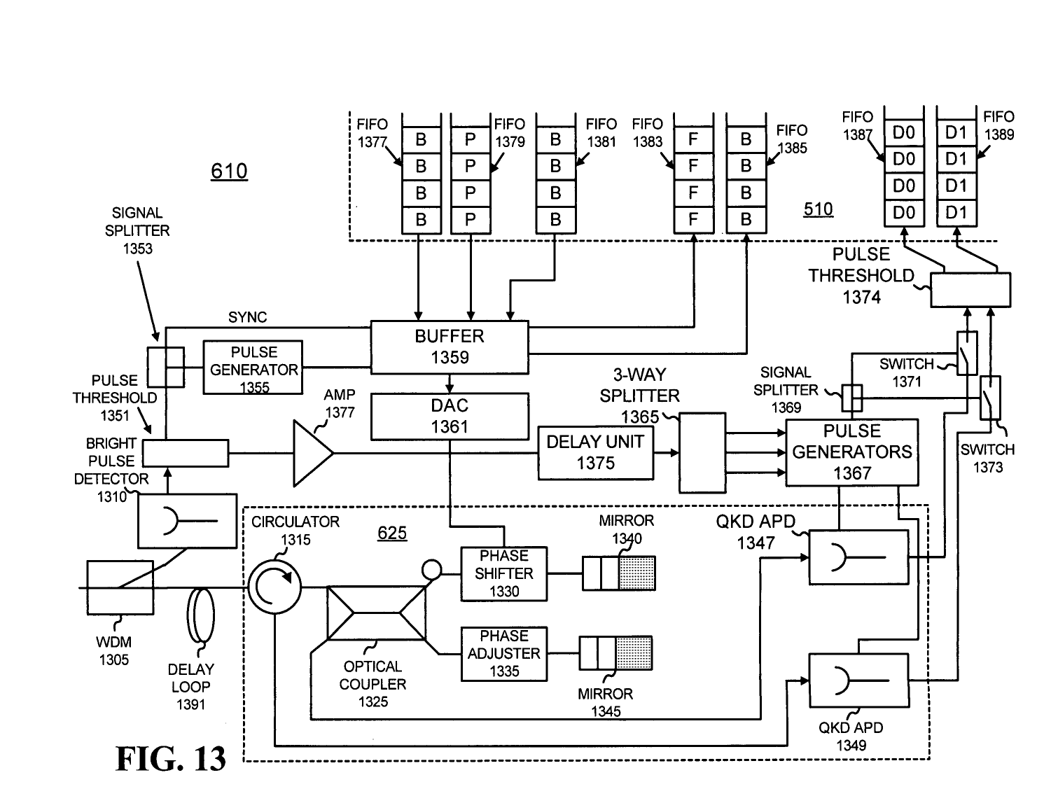

FIG. 13 illustrates exemplary components of a QKD receiver 610 consistent with an aspect of the invention. QKD receiver 610 may include a WDM 1305, a bright pulse detector 1310, a circulator 1315, an optical coupler 1325, a phase shifter 1330, a phase adjuster 1335, mirrors 1340 and 1345, a QKD APD 1347, and a QKD APD 1349.

QKD receiver 610 may further include a pulse threshold device 1351, a signal splitter 1353, a pulse generator 1355, a buffer 1359, a DAC 1361, an amplifier 1377, a delay unit 1375, a three-way splitter 1365, pulse generators 1367, a signal splitter 1369, switches 1371 and 1373, a pulse threshold device 1374, FIFO queues 1377, 1379, 1381, 1383, 1385, 1387 and 1389 of memory 510 and a delay loop 1391.

WDM 1305 may demultiplex optical pulses transmitted from a QKD transmitter 605 of another QKD endpoint 405. WDM 1305 may, for example, demultiplex bright pulses at 1550.92 nm wavelength to bright pulse detector 1310. WDM 1305 may further, for example, demultiplex dim pulses at 1550.12 nm wavelength to circulator 1315 via delay loop 1391. Delay loop 1391 may delay dim pulses as they pass from WDM 1305 to circulator 1315, so that the bright pulse corresponding to a given dim pulse may be detected at bright pulse detector 1310, and a subsequent gating voltage may be applied by pulse generator 1367 to QKD APDs 1347 and 1349 just prior to the dim pulse arriving at QKD APDs 1347 and 1349.

Circulator 1315 may pass the demultiplexed dim pulses to optical coupler 1325. Optical coupler 1325 may provide dim pulses from circulator 1315 to phase shifter 1330 and phase adjuster 1335. A basis value (B), clocked out of FIFO 1381, may be applied to phase shifter 1330 via buffer 1359 and DAC 1361. The basis value B from FIFO 1381 may indicate either a 0-π basis or a π/2-3π/2 basis. FIFOs 1377 and 1379 may output bits of phase voltage (B-P) for modulating receiver 610's basis and path length control. DAC 1361 may translate the basis value B to an output voltage that adjusts the phase shift of phase shifter 1330 an amount corresponding to the output voltage. Phase adjuster 1335 may include an open-air optical path, the length of which may be adjusted to produce a variable optical delay.

Dim pulses passing through phase shifter 1330 may be applied to mirror 1340. Mirror 1340 may include, for example, a Faraday mirror that reflects incident light such that the polarization of light returning to optical coupler 1325 is the same for each arm of optical coupler 1325, thus, producing interference with high visibility, regardless of the polarization of the incoming dim pulse, which may have been set to an arbitrary value by passing through an optical fiber. The dim pulses reflected from mirror 1340 may be coupled, via optical coupler 1325, to QKD APD 1347. Dim pulses passing through phase adjuster 1335 may be applied to mirror 1345. Mirror 1345 may include, for example, a Faraday mirror. The dim pulses reflected from mirror 1345 may be coupled, via optical coupler 125 and circulator 1315, to QKD APD 1349.

Bright pulse detector 1310 may pass an electrical annunciator pulse, indicating receipt of a bright photon pulse, to pulse threshold device 1351. Pulse threshold device 1351 may provide a logic pulse for each bright pulse received at detector 13 10 to trigger the gating of QKD APDs 1347 and 1349 via amplifier 1377, delay unit 1375, three-way splitter 1365, and pulse generators 1367. Each logic pulse provided by pulse threshold device 1351 may be delayed by delay unit 1375 and split into three logic pulses by splitter 1365. A first logic pulse from splitter 1365 may, via one of pulse generators 1367, control switches 1371 and 1373. A second logic pulse from splitter 1365 may, via another one of pulse generators 1367, control the gating of QKD APD 1347. A third logic pulse from splitter 1365 may, via a further one of pulse generators 1367, control the gating of QKD APD 1349.

Delay unit 1375 may delay the logic pulse trigger from pulse threshold device 1351 a sufficient interval such that QKD APDs 1347 and 1349 are gated, via switches 1371 and 1373, precisely at a time a subsequent dim photon pulse arrives. At the receipt of a dim photon pulse at either QKD APD 1347 or 1349, the outputs of the APDs may be sampled by pulse threshold device 1374. Logic high or low symbols corresponding to the output (designated as DO) from QKD APD 1347 may be provided to FIFO 1387 via pulse threshold device 1374. Logic high or low symbols corresponding to the output (designated as D1) from QKD APD 1349 may be provided to FIFO 1389 via pulse threshold device 1374.

Pulse threshold device 1351 may further provide a logic pulse, corresponding to each received bright photon pulse, as a trigger to FIFOs 1377, 1379, 1381, 1383, 1385, 1387 and 1389. The trigger may “clock” data in or out of each of the FIFOs. Pulse threshold device 1351 may also provide a logic pulse, via signal splitter 1353, to trigger pulse generator 1355. Pulse generator 1355, responsive to a trigger pulse from pulse threshold device 1351, may pass a framing symbol F to FIFO 1383 via buffer 1359. This framing symbol F may be accompanied by the basis value B, originally from FIFO 1381, which was used to demodulate the accompanying dim pulse, so that the value B may be stored in read-back FIFO 1385. This read-back of the B value for a given pulse eliminates the need for timing synchronization between the computer using memory 510 and the opto-electronic subsystem.

### Exemplary Qframe/Photon Pulse Mapping

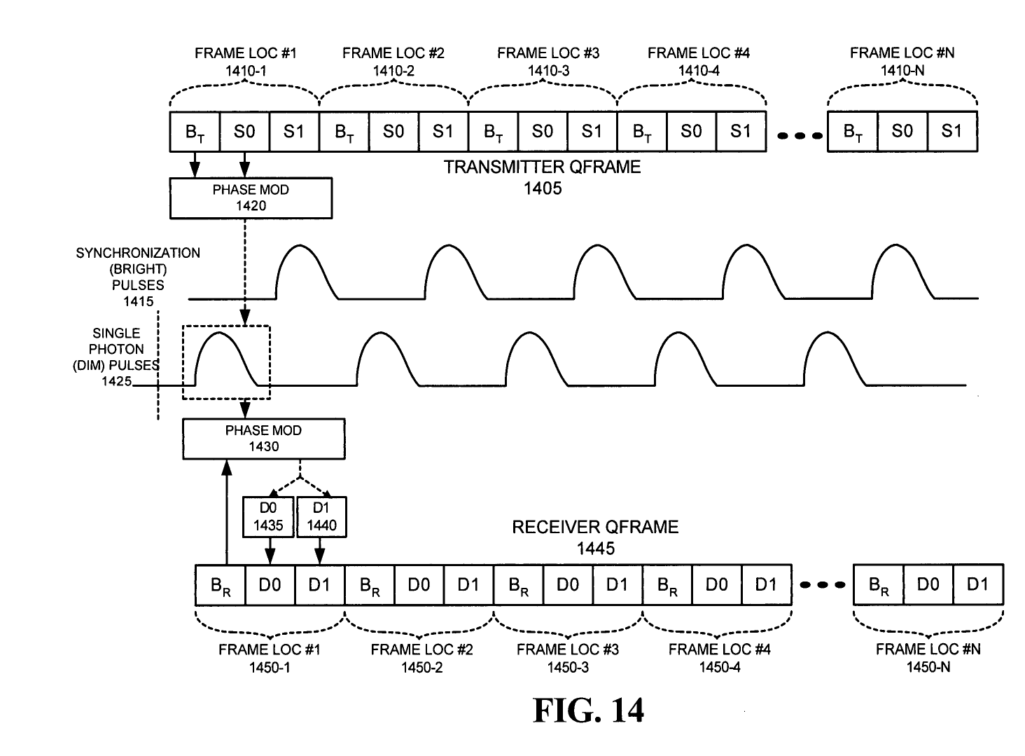

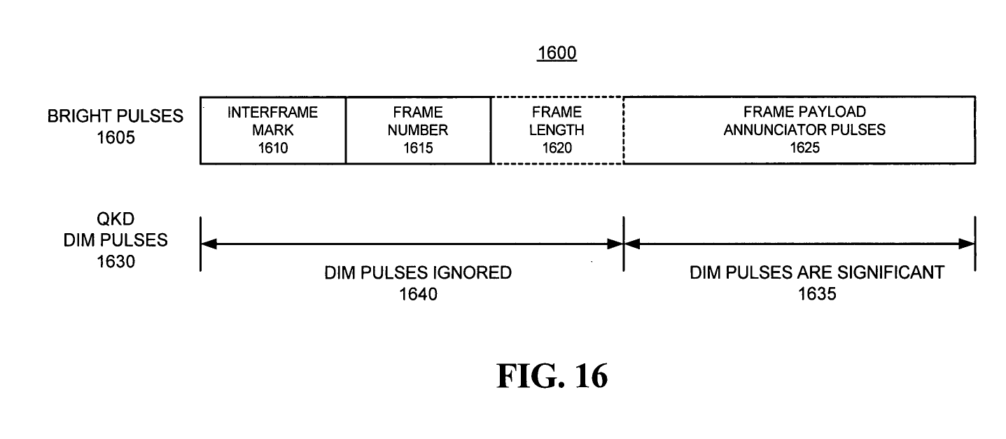

FIG. 14 illustrates an exemplary mapping between a first Qframe 1405 constructed at QKD transmitter 605, and a second Qframe 1445 constructed at QKD receiver 610, and “bright” and “dim” pulses transmitted by QKD transmitter 605. Bright pulses 1415 may indicate synchronization timing and frame boundaries (as described in more detail below with respect to FIG. 16). Dim pulses 1425 may contain quantum cryptographic key symbols encoded via modulation of, for example, the phase of the dim photon pulse transmitted from QKD transmitter 605. As shown in FIG. 14, transmission of each bright pulse 1415 may be delayed with respect to each dim pulse 1425 to minimize the effect that each bright pulse 1415 may have on the reception of each dim pulse 1425. Therefore, whatever light that “spills over” from the bright pulse channel into the dim pulse detector, e.g., due to imperfections in WDM 1305, should “hit” the QKD APDs after the dim pulse, rather than before it, thus diminishing the chance of stray light “confusing” the dim pulse detection. Delay of each bright pulse 1415 with respect to each dim pulse 1425 also allows the bright and dim pulses to operate at very close frequencies, thus minimizing any timing drift between the pulses caused by frequency-dependent velocity differences through the optical fiber. In one exemplary implementation, each “bright” pulse 1415 may lag a corresponding “dim” pulse 1425 by approximately 20.5 ns.

A transmitter Qframe 1405 may include multiple frame locations (frame loc #1 1410-1 through frame loc #N 1410-N), each of which may include a number of symbol values. A frame length may determine the number of frame locations in transmitter Qframe 1405. The frame length may be fixed, or may vary with each frame. The symbols of each frame location may include a basis symbol B_{T}, a first symbol SO and a second symbol S1. Basis value B_{T} may indicate one of two bases. A first basis may include a phase shift of 0 or π. A second basis may include a phase shift of π/2 or 3π/2. Symbols S0 and S1 may, together, indicate a quantum cryptographic key symbol. For example, S0 and S1 symbols of “01” may indicate a key symbol of “0.” As an additional example, S0 and S1 symbols of “10” may indicate a key symbol of “1.” Basis symbol B_{T} and each symbol S0 and S1 may be used to phase modulate 1420 an outgoing “dim” pulse 1425 from QKD transmitter 605.

A receiver Qframe 1445 may include multiple frame locations (frame loc #1 1450-1 through frame loc #N 1450-N), each of which may include a number of symbol values. A frame length may determine the number of frame locations in receiver Qframe 1445. The frame length may be fixed, or may vary with each frame. The symbols of each frame location may include a basis symbol B_{R}, a first detected symbol D0 1435 and a second detected symbol D1 1440. Basis value B_{R} may indicate one of two bases. A first basis may include a phase shift of 0 or π. A second basis may include a phase shift of π/2 or 3π/2. Basis value B_{R} may be used to phase modulate 1430 a received dim pulse 1425. D0 1435 may indicate a symbol detected at QKD APD 1347 of QKD receiver 610. D1 1440 may indicate a symbol detected at QKD APD 1349 of QKD receiver 610.

### Exemplary Bright Pulse Symbol Encoding

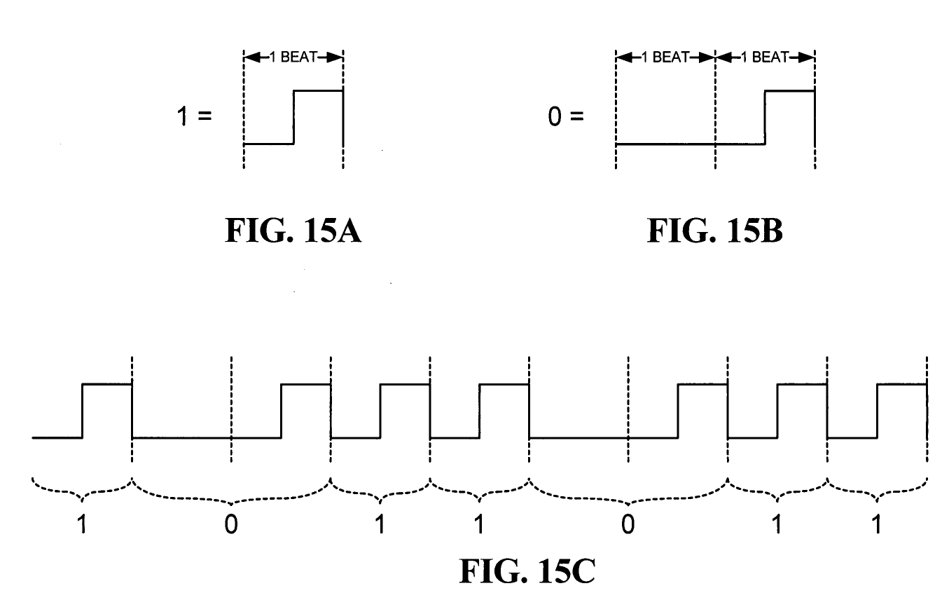

FIGS. 15A-15C illustrate exemplary bright photon pulse symbol encoding consistent with principles of the invention. As shown in FIG. 15A, a “1” symbol can be encoded by a rising edge of a bright photon pulse that is produced within a predetermined “beat” interval. As further shown in FIG. 15B, a “0” symbol can be encoded by a rising edge of a bright photon pulse that is delayed by at least one beat interval. Though FIG. 15B illustrates a rising edge delayed by one beat, the rising edge of the “0” symbol may be delayed an indeterminate period of time, as long as the delay is at least equal to or greater than one beat. For example, a period of a microsecond or more, followed by a rising edge, may indicate a “0” symbol, where a rising edge within a period of time less than that may indicate a “1” symbol. FIG. 15C illustrates an exemplary symbol series “1011011” encoded according to the bright pulse encoding scheme illustrated in FIGS. 15A and 15B.

### Exemplary Bright Pulse Frame Structure

FIG. 16 illustrates an exemplary bright pulse frame 1600 consistent with principles of the invention. Multiple “bright pulses” 1605 transmitted by bright source 1255 of QKD source 605 may define frame 1600. Frame 1600 may include an interframe mark 1610, a frame number 1615, an optional frame length 1620 and frame payload annunciator pulses 1625. Interframe mark 1610 may include a specially designated sequence of bright pulses that indicates a start of a new frame. For example, a symbol sequence 00000000001 may indicate a start of a new frame. As an additional example, a symbol sequence 1111111110 may indicate the start of a new frame. Frame number 1615 may include a number of bits that indicate a sequence number of frame 1600. For example, frame number 1615 may include 32 bits binary encoded with frame 1600's frame number.

Optional frame length 1620 may include a number of bits that indicate a frame length of frame 1600. Frame length 1620 may include, for example, 32 bits binary encoded with a length of frame 1600. Frame payload annunciator pulses 1625 may include a number of pulses that identify the boundaries of the payload of frame 1600. In a fixed length frame, frame payload annunciator pulses 1625 may include, for example, 1024 bits all set to “1”. In a variable length frame, for example, frame payload annunciator pulses 1625 may include a number of bits set to “1” as determined by frame length 1620.

During the bright pulses of the frame payload annunciator pulses 1625, the “dim” pulses 1630 transmitted by QKD transmitter 605 can be considered to be “significant”, and, thus, include the symbols of the frame payload (see 1635, FIG. 16). During the period of the frame spanning the interframe mark 1610, frame number 1615 and frame length 1620, any “dim” pulses transmitted by QKD transmitter 605 can be considered insignificant and, thus, ignored (see 1640, FIG. 16).

### Exemplary Quantum Cryptographic Frame Transmission Process

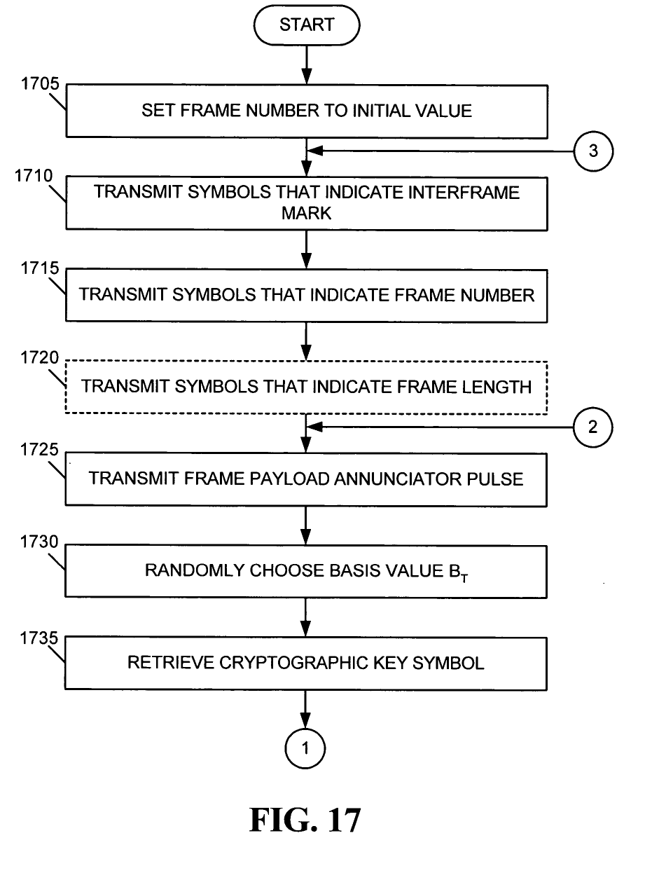

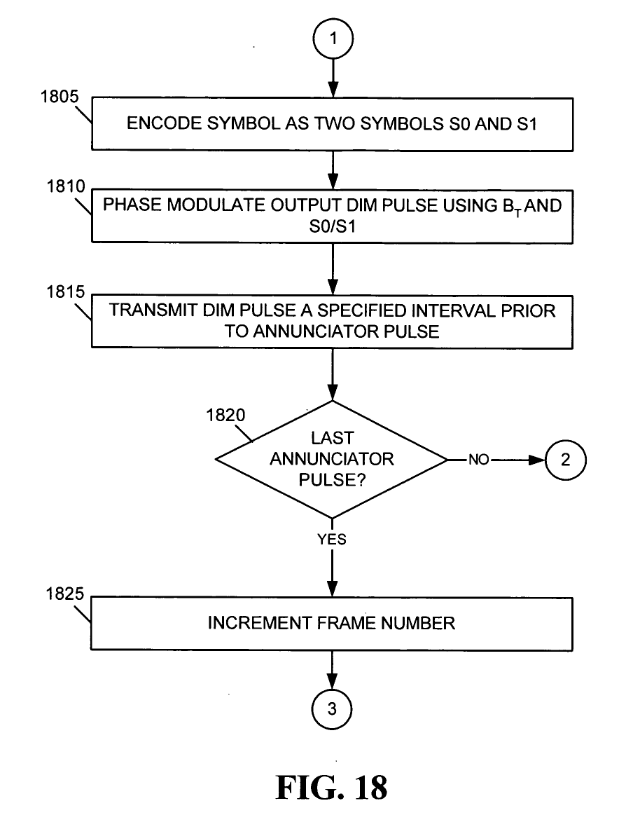

FIGS. 17 and 18 are flowcharts that illustrate an exemplary process, consistent with the principles of the invention, for framing and transmitting cryptographic key symbols over a quantum cryptographic link. As one skilled in the art will appreciate, the method exemplified by FIGS. 17 and 18 can be implemented as a sequence of instructions and stored in memory 510 of QKD endpoint 405 for execution by processing unit 505.

The exemplary process may begin with the setting of frame number 1615 to an initial value (block 1705)(FIG. 17). In some exemplary embodiments, for example, the frame number can be set to zero. Bright source 1255 of QKD transmitter 605 may then transmit symbols that indicate interframe mark 1610 (block 1710). For example, bright source 1255 may transmit the symbols “0000000001” or some other group of symbols to indicate a start of the frame. Bright source 1255 of QKD transmitter 605 may further transmit symbols that indicate frame number 1615 (block 1715). For example, bright source 1255 may transmit 32 symbols that include a binary encoded frame number. Bright source 1255 may also, optionally, transmit symbols that indicate frame length 1620 (block 1720). For example, bright source 1255 may transmit 32 symbols that include a binary encoded frame length value.

Bright source 1255 may transmit a single frame payload annunciator pulse 1625 (block 1725). This annuniciator pulse may be used for synchronization timing and for setting a frame boundary (e.g., the first annunciator pulse) for the transmitted payload symbols. A basis value B_{T} may be randomly chosen by, for example, processing unit 505 (block 1730). The basis value B_{T} may indicate whether a cryptographic key symbol will be encoded in a dim photon pulse by phase shifting the pulse along a 0-π basis or a π/2-3π/2 basis. Processing unit 505 may retrieve a cryptographic key symbol (block 1735). The key symbol may be previously generated according to any convention encryption key generation algorithm and stored in memory 510. Processing unit 505 may then encode the retrieved key symbol as two symbols S0 and S1 (block 1805) (FIG. 18). Thus, a “0” key symbol may be encoded as the symbols “01” and a “1” key symbol may be encoded as the symbols “10.” Phase shifter 1220 may phase modulate an output dim pulse from QKD source 1205 using basis value B_{T} and one of the encoded symbol values S0 and S1 retrieved from FIFO 1267 (block 1810). For example, if transmitting S0 equal to 0, and the basis value B_{T} has been chosen as zero, then the outgoing dim pulse can be encoded with a phase shift of 0. As another example, if transmitting S0 equal to 1, and the basis value B_{T} has been chosen as zero, then the outgoing dim pulse can be encoded with a phase shift of π. QKD source 1205 may transmit, via optical attenuator 1235, the phase encoded dim photon pulse a specified interval prior to transmission of the frame payload annunciator pulse (block 1815).

Processing unit 505 may determine whether the transmitted frame payload annunciator pulse was the last annunciator pulse of frame payload annunciator pulses 1625 (block 1820). If not, the exemplary process may return to block 1725 with the transmission of the next frame payload annunciator pulse. If the transmitted frame payload annunciator pulse was the last pulse of the frame, then processing unit 505 may increment frame number 1615 (block 1825) and the exemplary process may return to block 1710 above to begin transmission of the next frame.

### Exemplary Quantum Cryptographic Frame Reception Process

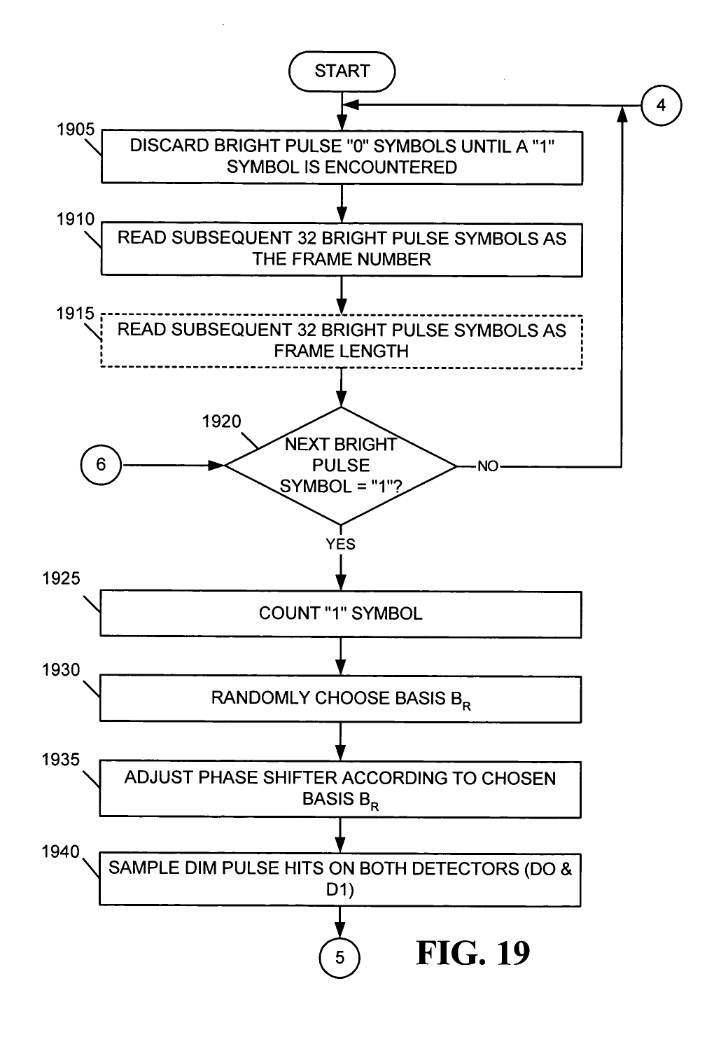

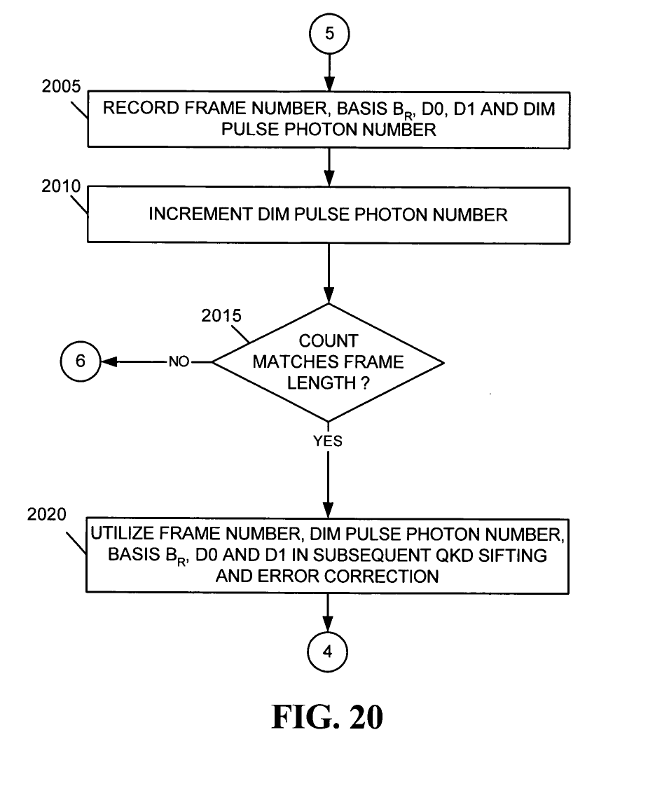

FIGS. 19 and 20 are flowcharts that illustrate an exemplary process, consistent with the present invention, for receiving and interpreting frames of transmitted cryptographic key symbols. As one skilled in the art will appreciate, the method exemplified by FIGS. 19 and 20 can be implemented as a sequence of instructions and stored in memory 510 of QKD endpoint 405 for execution by processing unit 505.

The exemplary process may begin with the reception of bright pulses at QKD receiver 610 and the discarding of “0” symbols until a “1” symbol is received at bright pulse detector 1310 (block 1905)(FIG. 19). The discarded “0” symbols followed by the “1” symbol may indicate interframe mark 1610. Following the “1” symbol, the subsequent 32 symbols may be read as frame number 1615 (block 1910). The 32 symbols may, for example, include the frame number as a binary encoded value. The symbols following the frame number 1615 may, optionally, be read as frame length 1620 (block 1915). The frame length symbols may include, for example, 32 symbols that include the frame length encoded as a binary encoded value.

A determination may be made whether the next received bright pulse symbol, following the pulses of frame number 1615 or optional frame length 1620, equals the “1” symbol (block 1920). If not, then the exemplary process may return to block 1905 above. If the next bright pulse symbol equals the “1” symbol, indicating the start of the frame payload, then the “1” symbol may be counted by, for example, processing unit 505 (block 1925). Processing unit 505 may randomly choose a basis value B_{R} (block 1930) and may adjust phase shifter 1330, via buffer 1359 and DAC 1361, according to the chosen basis (block 1935). For example, with a chosen basis value B_{R} of 0, phase shifter 1330 may adjust the phase of a received dim pulse by zero degrees. With a chosen basis value B_{R} of 1, for example, phase shifter 1330 may adjust the phase of a received dim pulse by π/2 degrees.

Dim pulse hits on both detectors 1350 and 1360 may then be sampled to produce values D0 and D1 (block 1940). A current frame number, basis B_{R}, values D0 and D1, and the dim pulse photon number corresponding to the current received dim photon pulse may be recorded in, for example, memory 510 (block 2005)(FIG. 20). The dim pulse photon number may then be incremented (block 2010). A determination may then be made whether the symbol count (block 1925 above) matches the frame length (block 2015). For example, if the frame length includes 1024 symbols, the end of the frame will occur when the symbol count equals 1024. If the symbol count does not match the frame length, the exemplary process may return to block 1920 for receipt of the next bright annunciator pulse. If the symbol count matches the frame length, then the frame number, dim pulse photon number, basis B_{R}, and D0 and D1 values may be utilized in subsequent QKD sifting and error correction (block 2020). QKD sifting and error correction may be performed according to existing techniques. The exemplary process may then return to block 1905 to begin the reception of another frame.

### Conclusion

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. Furthermore, while wavelength division multiplexing of the bright and dim pulses has been described above, time division multiplexing may be used, alternatively, or in conjunction with wavelength division multiplexing, for transmitting the bright and dim pulses over the quantum cryptographic link (e.g., bright pulses alternating with dim pulses in a time division manner). Additionally, while exemplary embodiments of the present invention have been described as using optical QKD pulses (i.e., photon pulses) for encoding and transmitting cryptographic keys, it will be appreciated that other non-optical pulses that include, for example, individual atoms, electrons, etc., may alternatively be used. In embodiments employing non-optical pulses, the individual quantum particles (e.g., atoms, electrons) may be modulated to encode cryptographic key symbols.

While a series of acts has been described with regard to FIGS. 17-20, the order of the acts may vary in other implementations consistent with the present invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A quantum cryptographic key distribution (QKD) transmitter, comprising;
an integrated photonic circuit configured to distribute encryption key material using quantum cryptographic mechanisms.

2. The QKD transmitter of claim 1, wherein the integrated photonic circuit is implemented on a single chip.

3. The QKD transmitter of claim 1, further comprising:
control electronics coupled to the integrated photonic circuit and configured to control the operation of the integrated photonic circuit.

4. The QKD transmitter of claim 3, wherein the integrated photonic circuit and control electronics are implemented on a single chip.

5. The QKD transmitter of claim 3, wherein the integrated photonic circuit and the control electronics are implemented on different chips.

6. The QKD transmitter of claim 1, wherein the integrated photonic circuit comprises:
a first photon source;
an interferometer coupled to the first photon source; and
a phase modulator coupled to the interferometer and configured to modulate a phase of photons emitted by the first photon source.

7. The QKD transmitter of claim 6, wherein the first photon source comprises a pulsed light source.

8. The QKD transmitter of claim 6, wherein the first photon source comprises a continuous wave light source and further comprising:
a semiconductor optical amplifier (SOA) coupled to an output of the first photon source

9. The QKD transmitter of claim 6, wherein the integrated photonic circuit further comprises:
an attenuator coupled to an output of the interferometer.

10. The QKD transmitter of claim 9, wherein the integrated photonic circuit further comprises:
a second photon source; and
a combiner coupled to an output of the second photon source and to an output of the attenuator.

11. The QKD transmitter of claim 6, wherein the interferometer comprises a Mach-Zehnder interferometer.

12. The QKD transmitter of claim 1, wherein the integrated photonic circuit is implemented in III-V semiconducting materials.

13. The QKD transmitter of claim 1, wherein the integrated photonic circuit is implemented in silica or silicon material.

14. A system, comprising:
an interferometer formed in an integrated circuit;
a first laser formed in the integrated circuit and coupled to a first side of the interferometer;
an attenuator formed in the integrated circuit and coupled to a second side of the interferometer; and
a phase modulator formed in the integrated circuit and coupled to the interferometer.

15. The system of claim 14, wherein the interferometer, first laser, attenuator and phase modulator are integrated on a single chip.

16. The system of claim 14, further comprising:
a second laser formed in the integrated circuit; and
a combiner formed in the integrated circuit and coupled to the second laser and to an output of the attenuator.

17. The system of claim 16, further comprising:
an optical isolator coupled to an output of the combiner.

18. A quantum cryptographic key distribution (QKD) transmitter, comprising;
an integrated photonic circuit configured to distribute encryption key material using quantum cryptographic mechanisms via multiple channels.

19. The QKD transmitter of claim 18, wherein the integrated photonic circuit is configured to wavelength division multiplex the multiple channels.

20. The QKD transmitter of claim 18, wherein the integrated photonic circuit is configured to time division multiplex the multiple channels.

21. The QKD transmitter of claim 18, the integrated photonic circuit further comprising:
a first portion of the integrated photonic circuit configured to distribute encryption key material using quantum cryptographic mechanisms via a first channel of the multiple channels; and
a second portion of the integrated photonic circuit configured to distribute encryption key material using quantum cryptographic mechanisms via a second channel of the multiple channels.

22. The QKD transmitter of claim 21, wherein the first portion of the integrated photonic circuit comprises:
a first interferometer;
a first laser coupled to an input of the first interferometer and configured to transmit light over the first channel of the multiple channels;
a first phase modulator coupled to the first interferometer; and
a first attenuator coupled to an output of the first interferometer.

23. The QKD transmitter of claim 22, wherein the second portion of the integrated photonic circuit comprises:
a second interferometer;
a second laser coupled to an input of the second interferometer and configured to transmit light over the second channel of the multiple channels;
a second phase modulator coupled to the second interferometer; and
a second attenuator coupled to an output of the second interferometer.

24. The QKD transmitter of claim 23, wherein the integrated photonic circuit further comprises:
a combiner coupled to an output of the first and second attenuators; and
an optical isolator coupled to an output of the combiner.

25. A quantum cryptographic key distribution (QKD) transmitter, comprising;
an integrated photonic circuit configured to distribute encryption key material using at least one of dim light pulses or single photon light pulses and synchronization light pulses.

26. The QKD transmitter of claim 25, wherein the integrated photonic circuit uses 1 synchronization light pulse for N>=1 dim or single photon light pulses.

27. The QKD transmitter of claim 25, wherein the at least one of dim light or single photon light pulses comprise light pulses at a first wavelength.

28. The QKD transmitter of claim 27, wherein the synchronization light pulses comprise light pulses at a second wavelength, wherein the first wavelength is different than the second wavelength.
